(19) United States
(12) Patent Application Publication
(10) Pub. No.: US 2007/0213563 A1
(43) Pub. Date: Sep. 13, 2007

(54) Mixtures composed of monocarboxy-functionalized dialkylphosphinic acid salts, their use und a process for their preparation

(75) Inventors: Wiebke Maas, Huerth (DE); Werner Krause, Huerth (DE); Harald Bauer, Kerpen (DE)

Correspondence Address: CLARIANT CORPORATION;INTELLECTUAL PROPERTY DEPARTMENT, 4000 MONROE ROAD, CHARLOTTE, NC, 28205, US

(73) Assignee: Clariant International Ltd

(21) Appl. No.: 11/714,331

(22) Filed: Mar. 6, 2007

(30) Foreign Application Priority Data
Mar. 7, 2006 (DE) 10 2006 010 352.1

(51) Int. Cl. C07F 9/02

(52) U.S. Cl. 568/8

(57) ABSTRACT

The invention relates to mixtures composed of monocarboxy-functionalized dialkylphosphinic salts and of further components, which comprise A) from 98 to 100% by weight of monocarboxy-functionalized dialkylphosphinic salts of the formula (I)

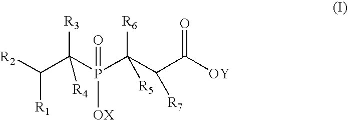

in which X and Y are different, where X is Ca, Al, or Zn, and Y is methyl, ethyl, n-propyl, isopropyl, n-butyl, isobutyl, tert-butyl, phenyl, 2-hydroxyethyl, 2,3-dihydroxypropyl, 2-hydroxypropyl, 3-hydroxypropyl, 4-hydroxybutyl, 3-hydroxybutyl, 2-hydroxybutyl, and/or 6-hydroxyhexyl, allyl and/or glycerol;
or X and Y are different and are Mg, Sb, Sn, Ge, Ti, Fe, Zr, Ce, Bi, Sr, Mn, Cu, Ni, Li, Na, K, H, and/or a protonated nitrogen base;
or X and Y are identical or different and each is then Ca, Al, or Zn;
R₁, R₂, R₃, R₄, R₅, R₆, and R₇ are identical or different and, independently of one another, are H, methyl, ethyl, n-propyl, isopropyl, n-butyl, isobutyl, tert-butyl, and/or phenyl, and
B) from 0 to 2% by weight of halogens,
where the entirety of the components always amounts to 100% by weight; and to a process for their preparation and to their use.

The present invention is described in the German priority application No. 10 2006 010 352.1, filed Jul. 03, 2006, which is hereby incorporated by reference as is fully disclosed herein.

Mixtures composed of monocarboxy-functionalized dialkylphosphinic salts and of further components, a process for their preparation and their use

The invention relates to mixtures composed of monocarboxy-functionalized dialkylphosphinic salts and of further components, to a process for their preparation and to their use.

Many monocarboxy-functionalized dialkylphosphinic acids and derivatives of these, among which are their salts, are known; they are mainly used as flame retardants. Various processes can be used for their preparation.

U.S. Pat. No. 6,753,363 describes, for example, flame-retardant polyacetal resins rendered flame-retardant via addition of aluminum 3-(methylhydroxyphosphinyl)propionate.

Another use of salts of monocarboxy-functionalized dialkylphosphinic acids is as additive for polymers with improved transparency and with advantageous mechanical properties, and for production of optical materials.

Various processes are known for the preparation of the monocarboxy-functionalized dialkylphosphinic acid derivatives, which can be reacted to give the corresponding salts.

The prior art contains many descriptions of processes in which a monocarboxy-functionalized dialkylphosphinic acid or its anhydride is obtained by reacting phosphonous dihalides (dihalophosphines) with activated olefinic compounds, e.g. acrylic acid derivatives or methacrylic acid derivatives (Houben-Weyl, volume 12/1, p. 230; V. K. Khajrullin, F. M. Kondrat'eva and A. N. Pudovik, Z. obsc. Chim. 38, 291-294 (1968); DE-A-2 528 420, JP-A-05/194 562).

A disadvantage of the abovementioned prior art is formation of halogen-containing by-products resulting from the synthesis. Halogen-containing compounds here are chemical compounds in which atoms of the 7^{th} main group are present, in particular fluorine, chlorine, bromine, and iodine, chemically bonded to carbon or phosphorus. Other halogen-containing compounds are salts which contain halide anions. Halogen-containing compounds, in particular chlorine-containing compounds, are often many times more corrosive than halogen-free compounds. A disadvantage of halogen-containing compounds in relation to use as flame retardants is that corrosive and toxic gases can form in the event of a fire, and these make the use of compounds of this type as flame retardants at least questionable, or indeed entirely impossible.

Among the phosphonous dihalides most frequently used is methyldichlorophosphine, which in turn has hitherto been prepared by a very complicated synthesis from phosphorus trichloride and methyl chloride in the presence of aluminum chloride (Houben-Weyl, volume 12/1, p. 306). The reaction is highly exothermic and is difficult to control under industrial conditions. Furthermore, various by-products, in particular halogen-containing by-products, are formed, and these, like some of the abovementioned starting materials themselves, are toxic and/or corrosive, i.e. highly undesirable. The use of these starting materials and the by-products obtained therefrom is undesirable in view of corrosion and environmental incompatibility.

Another method for synthesis of monocarboxy-functionalized dialkylphosphinic acids is based on the reaction of bis(trimethylsilyl) phosphonite, HP(OSiMe₃)₂, with α,β-unsaturated carboxylic acid components, subsequent alkylation with alkyl halides by the Arbuzov reaction, and alcoholysis to give the corresponding dialkylphosphinic acid (Kurdyumova, N. R.; Rozhko, L. F.; Ragulin, V. V.; Tsvetkov, E. N.; Russian Journal of General Chemistry (Translation of Zhurnal Obshchei Khimii) (1997), 67(12), 1852-1856). This synthesis route too, has the disadvantage of requiring the use of halogen-containing compounds. The bis(trimethylsilyl)phosphonite used as starting material here is obtained from potassium hypophosphite or from ammonium hypophosphite via reaction with hexamethyldisilazane. Hexamethyldisilazane is not available in industrial quantities, and its use is not cost-effective, since its preparation is likewise complicated. This route cannot be used for economic and cost-effective preparation of genuinely halogen-free monocarboxy-functionalized dialkylphosphinic acids and of possible derivatives thereof.

It is therefore an object of the present invention to provide extremely low-halogen-content, or indeed halogen-free, (metal) salts of monocarboxy-functionalized dialkylphosphinic acid.

This object is achieved via mixtures composed of monocarboxy-functionalized dialkylphosphinic salts and of further components, which comprise

### A) from 98 to 100% by weight of monocarboxy-functionalized dialkylphosphinic salts of the formula (I)

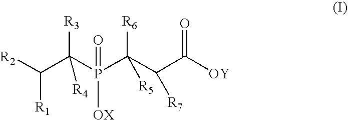

in which X and Y are different, where X is Ca, Al, or Zn, and Y is methyl, ethyl, n-propyl, isopropyl, n-butyl, isobutyl, tert-butyl, phenyl, 2-hydroxyethyl, 2,3-dihydroxypropyl, 2-hydroxypropyl, 3-hydroxypropyl, 4-hydroxybutyl, 3-hydroxybutyl, 2-hydroxybutyl, and/or 6-hydroxyhexyl, allyl and/or glycerol;
or X and Y are different and are Mg, Sb, Sn, Ge, Ti, Fe, Zr, Ce, Bi, Sr, Mn, Cu, Ni, Li, Na, K, H, and/or a protonated nitrogen base;
or X and Y are identical or different and each is then Ca, Al, or Zn;

### R₁, R₂, R₃, R₄, R₅, R₆, and R₇ are identical or different and, independently of one another, are H, methyl, ethyl, n-propyl, isopropyl, n-butyl, isobutyl, tert-butyl, and/or phenyl, and

### B) from 0 to 2% by weight of halogens,

where the entirety of the components always amounts to 100% by weight.

The mixtures preferably comprise from 99.9995 to 100% by weight of monocarboxy-functionalized dialkylphosphinic salts of the formula (I) and from 0 to 0.0005% by weight of halogens.

The monocarboxy-functionalized dialkylphosphinic salt is preferably aluminum(III) 3-(ethylhydroxyphosphinyl)propionate, calcium(II) 3-(ethylhydroxyphosphinyl)propionate, cerium(III) 3-(ethyl-hydroxyphosphinyl)propionate, zinc(II) 3-(ethyl-hydroxyphosphinyl)propionate, aluminum(III) 3-(ethylhydroxyphosphinyl)-2-methylpropionate, the methyl ester of aluminum(III) 3-(propylhydroxyphosphinyl)propionate, aluminum(III) 3-(propylhydroxyphosphinyl)propionate, zinc(II) 3-(propylhydroxy-phosphinyl)propionate, aluminum(III) 3-(ethylhydroxyphosphinyl)butyrate, zinc(II) 3-(ethylhydroxy-phosphinyl)butyrate, aluminum(III) 3-(butylhydroxyphosphinyl)-propionate, aluminum(III) 3-(propylhydroxyphosphinyl)butyrate, aluminum(III) 3-(ethylhydroxyphosphinyl)pentanoate, aluminum(III) 3-(propylhydroxyphosphinyl)-2-methylpropionate, aluminum(III) 3-(butylhydroxyphosphinyl)-2-methylpropionate, aluminum(III) 3-(ethylhydroxyphosphinyl)-2-methylbutyrate, the methyl ester of aluminum(III) 3-(ethylhydroxyphosphinyl)propionate, the 2-hydroxyethyl ester of aluminum(III) 3-(ethylhydroxyphosphinyl)propionate, the 2-hydroxyethyl ester of zinc(II) 3-(ethylhydroxyphosphinyl)propionate, the 2,3-dihydroxypropyl ester of aluminum(III) 3-(ethylhydroxyphosphinyl)propionate and/or the allyl ester of aluminum(III) 3-(ethylhydroxyphosphinyl)-2-methylpropionate.

The object is also achieved via a process for preparation of mixtures as claimed in one or more of claims 1 to 3, which comprises reacting, in a stage 1 of the process, hypophosphorous acid or its salts (component C) of the formula II

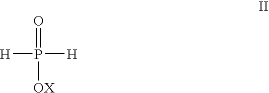

in which X is H, Na, K, or NH₄; in the presence of a free-radical initiator with an α,β-unsaturated carboxylic acid derivative (component D) of the formula III

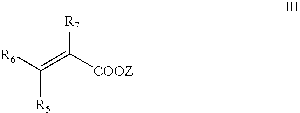

in which R₅, R₆, and R₇ are defined as in formula I, and Z is H, C₁₋₁₈-alkyl, or C₆₋₁₈-aryl, or is Y; and with an olefin (component E) of the formula IV

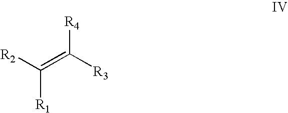

in which R₁, R₂, R₃, and R₄ are defined as in formula I and, in a stage 2 of the process, reacting the resultant monocarboxy-functionalized dialkylphosphinic acid and/or its alkali metal salts with metal compounds of Mg, Ca, Al, Sb, Sn, Ge, Ti, Fe, Zr, Zn, Ce, Bi, Sr, Mn, and/or with a protonated nitrogen base to give the dialkylphosphinates of these metals and/or to give the nitrogen compound of formula I.

It is preferable that X is H and Z is H, methyl, ethyl, n-propyl, isopropyl, n-butyl, isobutyl, tert-butyl, hydroxyethyl, or hydroxypropyl.

The process is preferably one wherein, in stage 1 of the process, in a step 1, component C is reacted in the presence of a free-radical initiator with component E to give an alkylphosphonous acid and, in step 2, the resultant reaction solution is esterified with an alcohol and phosphonous ester produced here is removed by distillation and then, in a step 3, is reacted in the presence of a free-radical initiator or of a basic initiator with component D, and then stage 2 of the process is carried out.

It is preferable that, in step 2, the alkylphosphonous acid is directly esterified with a linear or branched alcohol of the formula M-OH, where M is a linear or branched alkyl radical having from 1 to 10 carbon atoms.

It is preferable that the alcohol is n-butanol, isobutanol, or ethylhexanol.

It is preferable that component C is the ammonium or sodium salt of hypophosphorous acid.

It is preferable that the initiator is a free-radical, anionic, cationic, or photochemical initiator.

It is preferable that the initiator is peroxide-forming compounds and/or peroxo compounds, e.g. hydrogen peroxide, sodium peroxide, lithium peroxide, potassium persulfate, sodium persulfate, ammonium persulfate, sodium peroxodisulfate, potassium peroxoborate, peracetic acid, benzoyl peroxide, di-tert-butyl peroxide, and/or peroxodisulfuric acid, and/or is azo compounds, e.g. azodiisobutyronitrile, 2,2′-azobis(2-amidinopropane) dihydrochloride and/or 2,2′-azobis(N,N′-dimethyleneisobutyramidine) dihydrochloride.

It is preferable that the α,β-unsaturated carboxylic acids and, α,β-unsaturated carboxylic acid derivatives are acrylic acid, methyl acrylate, ethyl acrylate, methacrylic acid, hydroxyethyl acrylate, crotonic acid, ethyl crotonate, tiglic acid (trans-2,3-dimethylacrylic acid), (trans)-2-pentenoic acid, furan-2-carboxylic acid, and/or thiophene-2-carboxylic acid.

It is preferable that the olefin (component E) is ethylene, propylene, n-butene, and/or isobutene, or any desired mixture thereof, 1-hexene, 1-heptene, and/or 1-octene, or is allyl alcohol, allylamine, allylbenzene, allylanisole, styrene, α-methylstyrene, 4-methylstyrene, and/or vinyl acetate.

It is preferable that the reaction of component C with components D and/or E takes place at a temperature of from 50 to 150° C.

Another preferred method for the process comprises, in stage 1 of the process, reacting component C, in a step 1, with a ketone to give 1-hydroxy-1-dialkylphosphinate, reacting this 1-hydroxy-1-dialkylphosphinate, in a step 2, in the presence of a free-radical initiator with component D, then, in a step 3, removing the ketone, and reacting the resultant reaction mixture, in a step 4, in the presence of a free-radical initiator with component E, and then carrying out stage 2 of the process.

Another embodiment comprises, in stage 1 of the process, reacting component C, in a step 1, with a ketone to give 1-hydroxy-1-dialkylphosphinate, reacting this 1-hydroxy-1-dialkylphosphinate, in a step 2, in the presence of a free-radical initiator with component E, then, in a step 3, removing the ketone, and reacting the resultant reaction mixture, in a step 4, in the presence of a free-radical initiator with component D, and then carrying out stage 2 of the process.

The metal compounds of stage 2 of the process are preferably aluminum hydroxide, aluminum sulfates, zinc sulfate heptahydrate, magnesium chloride hexahydrate, and/or calcium chloride dihydrate.

The reaction in stage 2 of the process preferably takes place at a temperature of from 20 to 150° C.

The invention also provides the use of mixtures as claimed in one or more of claims 1 to 3 as flame retardants, for preparation of flame retardants, in flame-retardant molding compositions or in flame-retardant moldings, in flame-retardant films, in flame-retardant filaments, and in flame-retardant fibers.

It is preferable that the flame-retardant molding composition or the moldings, films, filaments, and fibers comprise from 1 to 50% by weight of the mixtures as claimed in one or more of claims 1 to 3, from 1 to 99% by weight of polymer or a mixture of the same, from 0 to 60% by weight of additives, and from 0 to 60% by weight of filler, where the entirety of the components always amounts to 100% by weight.

The inventive mixtures preferably comprise A) from 99.9995 to 100% by weight of aluminum(III) 3-(ethylhydroxyphosphinyl)propionate, calcium(II) 3-(ethylhydroxyphosphinyl)propionate, cerium(III) 3-(ethyl-hydroxyphosphinyl)propionate, zinc(II) 3-(ethylhydroxyphosphinyl)propionate, aluminum(III) 3-(ethylhydroxyphosphinyl)-2-methylpropionate, the methyl ester of aluminum(III) 3-(propylhydroxyphosphinyl)propionate, aluminum(III) 3-(propylhydroxyphosphinyl)propionate, zinc(II) 3-(propylhydroxyphosphinyl)propionate, aluminum(III) 3-(ethylhydroxyphosphinyl)butyrate, zinc(II) 3-(ethylhydroxy-phosphinyl)butyrate, aluminum(III) 3-(butylhydroxyphosphinyl)-propionate, aluminum(III) 3-(propylhydroxyphosphinyl)butyrate, aluminum(III) 3-(ethylhydroxyphosphinyl)pentanoate, aluminum(III) 3-(propylhydroxyphosphinyl)-2-methylpropionate, aluminum(III) 3-(butylhydroxyphosphinyl)-2-methylpropionate, aluminum(III) 3-(ethylhydroxyphosphinyl)-2-methylbutyrate, the methyl ester of aluminum(III) 3-(ethylhydroxyphosphinyl)propionate, the 2-hydroxyethyl ester of aluminum(III) 3-(ethylhydroxyphosphinyl)propionate, the 2-hydroxyethyl ester of zinc(II) 3-(ethylhydroxyphosphinyl)propionate, the 2,3-dihydroxypropyl ester of aluminum(III) 3-(ethylhydroxyphosphinyl)propionate and/or the allyl ester of aluminum(III) 3-(ethylhydroxyphosphinyl)-2-methylpropionate, and B) from 0 to 0.0005% by weight of chlorine.

In principle, the invention also comprises mixtures which comprise from 98 to 100% by weight of monocarboxy-functionalized dialkylphosphinic salts of the formula (I)

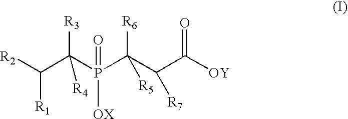

in which X is a metal of the first to fourth main group, of the transition metals, or else Sb, Bi, and Ce, and/or a protonated nitrogen base, Y is H, C₁-C₁₈-alkyl, C₆-C₁₈-aryl, C₆-C₁₈-aralkyl, C₆-C₁₈-alkylaryl, (CH₂)ₖOH, CH₂—CHOH—CH₂OH, (CH₂)ₖO(CH₂)ₖH, (CH₂)ₖ—CH(OH)—(CH₂)ₖH, (CH₂—CH₂O)ₖH, (CH₂—C[CH₃]HO)ₖH, (CH₂—C[CH₃]HO)ₖ(CH₂—CH₂O)ₖH, (CH₂—CH₂O)ₖ(CH₂—C[CH₃]HO)H, (CH₂—CH₂O)ₖ-alkyl, (CH₂—C[CH₃]HO)ₖ-alkyl, (CH₂—C[CH₃]HO)ₖ(CH₂—CH₂O)ₖ-alkyl, (CH₂—CH₂O)ₖ(CH₂—C[CH₃]HO)O-alkyl, (CH₂)ₖ—CH═CH(CH₂)ₖH, (CH₂)ₖNH₂, (CH₂)ₖN[(CH₂)ₖH]₂, where k is a whole number from 0 to 100, preferably from 2 to 10, or Y is defined in the same way as X, X and Y then being identical or being two different metals,
R₁, R₂, R₃, R₄, R₅, R₆, R₇ are identical or different and, independently of one another, are H, C₁-C₁₈-alkyl, C₆-C₁₈-aryl, C₆-C₁₈-aralkyl, C₆-C₁₈-alkylaryl, CN, CHO, OC(O)CH₂CN, CH(OH)C₂H₅, CH₂CH(OH)CH₃, 9-anthracene, 2-pyrrolidone, (CH₂)ₘOH, (CH₂)ₘNH₂, (CH₂)ₘNCS, (CH₂)ₘNC(S)NH₂, (CH₂)ₘSH, (CH₂)ₘS-2-thiazoline, (CH₂)ₘSiMe₃, C(O)R₈, (CH₂)ₘC(O)R₈, CH═CH—R₈, CH═CH—C(O)R₈, where R₈ is C₁-C₈-alkyl or C₆-C₁₈-aryl, and m is a whole number from 0 to 10, preferably from 1 to 10, and

### B) from 0 to 2% by weight of halogens,

where the entirety of the components is always 100% by weight.

The mixtures also comprise from 99 to 100% by weight of monocarboxy-functionalized dialkylphosphinic salts of the formula (I) and from 0 to 1% by weight of halogens.

The mixtures also comprise from 99.99 to 100% by weight of monocarboxy-functionalized dialkylphosphinic salts of the formula (I) and from 0 to 0.01% by weight of halogens.

It is preferable that the groups C₆-C₁₈-aryl, C₆-C₁₈-aralkyl and C₆-C₁₈-alkylaryl have substitution by SO₃X₂, —C(O)CH3, OH, CH₂OH, CH₃SO₃X₂, PO₃X₂, NH₂, NO₂, OCH₃, SH, and/or OC(O)CH₃.

R₁, R₂, R₃, R₄, R₅, R₆, and R₇ can be identical or different and, independently of one another, are H, C₁-C₆-alkyl and/or aryl.

It is preferable that X and Y are identical or different, each being Mg, Ca, Al, Sb, Sn, Ge, Ti, Fe, Zr, Zn, Ce, Bi, Sr, Mn, Cu, Ni, Li, Na, K, H, and/or a protonated nitrogen base, this therefore meaning that X and Y can be an identical metal cation or two different metal cations.

It is preferable that each of X and Y, being identical or different, is Ca, Al, or Zn.

It is preferable here that X and Y are different, X being Ca, Al, or Zn, and Y being methyl, ethyl, n-propyl, isopropyl, n-butyl, isobutyl, tert-butyl, phenyl, ethylene glycol, propyl glycol, butyl glycol, pentyl glycol, hexyl glycol, allyl, and/or glycerol.

Other suitable compounds are aluminum(III) 3-(propylhydroxyphosphinyl)-2-methylbutyrate, aluminum(III) 3-(butylhydroxyphosphinyl)-2-methylbutyrate, aluminum(III) 3-(butylhydroxyphosphinyl)butyrate, aluminum(III) 3-(propyl-hydroxyphosphinyl)pentanoate, aluminum(III) 3-(butylhydroxyphosphinyl)pentanoate, the 2-hydroxyethyl ester of aluminum(III) 3-(ethylhydroxyphosphinyl)-2-methylbutyrate, the 2-hydroxyethyl ester of aluminum(III) 3-(propylhydroxyphosphinyl)-2-methylbutyrate, the 2-hydroxypropyl ester of aluminum(III) 3-(ethylhydroxyphosphinyl)-2-methylbutyrate, the 2-hydroxypropyl ester of aluminum(III) 3-(propylhydroxyphosphinyl)-2-methylbutyrate, and/or the 2,3-dihydroxypropyl ester of aluminum(III) 3-(propylhydroxyphosphinyl)propionate.

The abovementioned object is also achieved via a process for preparation of mixtures as claimed in one or more of claims 1 to 4, which comprises, in a stage 1 of the process, reacting hypophosphorous acid or its salts (component C) of the formula II

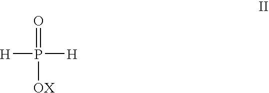

in which X is. H, Na, K, or NH₄; in the presence of a free-radical initiator with an α,β-unsaturated carboxylic acid derivative (component D) of the formula III

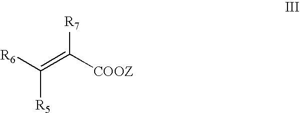

in which R₅, R₆, and R₇ are defined as in formula I and Z is H, C₁₋₁₈-alkyl, or C₆₋₁₈-aryl, or is Y; and with an olefin (component E) of the formula IV

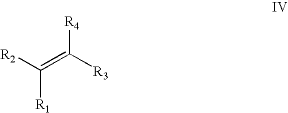

in which R₁, R₂, R₃, and R₄ are defined as in formula I, and, in a stage 2 of the process, reacting the resultant monocarboxy-functionalized dialkylphosphinic acid and/or its alkali metal salts with metal compounds of Mg, Ca, Al, Sb, Sn, Ge, Ti, Fe, Zr, Zn, Ce, Bi, Sr, Mn, and/or a protonated nitrogen base to give the dialkylphosphinic salts of these metals and/or the nitrogen compound of formula I.

The conduct of the process is preferably such that, in stage 1 of the process, in a first step of the process, component C is reacted in the presence of a free-radical initiator with component D, and in a second step of the process the resultant reaction solution is reacted likewise in the presence of a free-radical initiator with component E.

It is also preferable that, in stage 1 of the process, in a first step of the process, component C is reacted in the presence of a free-radical initiator with component E and, in a second step of the process, the resultant reaction solution is reacted likewise in the presence of a free-radical initiator with component D.

It is preferable to use the following molar ratios of components C, D, and E:

$$pC + {\sum }_{k = 1}^{n - 1} {x}_{k} D + \sum {y}_{k} {\sum }_{k = 1}^{n - 1} + ( α - {x}_{n} ) D + ( α - {y}_{n} ) E = A$$

where C is hypophosphorous acid or its salts of the formula II, D is the α,β-unsaturated carboxylic acid derivative or α,β-unsaturated carboxylic acid of the formula III, E is the olefin of the formula IV, and A is the monocarboxy-functionalized dialkylphosphinic salt of the formula I, and moreover:

$${\sum }_{k = 1}^{n} {x}_{k} = α and {\sum }_{k = 1}^{n} {y}_{k} = α ,$$

where α=from 1 to 3; 0.01≦xₖ, and yₖ≦α; p=from 0.5 to 3, and n=from 1 to 100.

It is preferable that the conduct of the process is such that, in stage 1 of the process, in a first step 1, component C is reacted in the presence of a free-radical initiator with a portion xₖ D of component D, the resultant reaction solution is reacted, in a step 2, in the presence of a free-radical initiator with the entire amount of component E, and the resultant reaction solution is reacted, in a step 3, in the presence of a free-radical initiator with the remaining portion (α-xₙ) D of component D.

The conduct of the process can moreover also be such that, in stage 1 of the process, in a first step 1, component C is reacted in the presence of a free-radical initiator with a portion yₖ E of component E, the resultant reaction solution is reacted, in a step 2, in the presence of a free-radical initiator with the entire amount of component D, and the resultant reaction solution is reacted, in a step 3, in the presence of a free-radical initiator with the remaining portion (α-yₙ) E of component E.

The conduct of the process can moreover also be such that, in stage 1 of the process, in a step 1, component C is reacted in the presence of a free-radical initiator with a portion xₖ D of component D, and the resultant reaction solution is reacted, in a step 2, in the presence of a free-radical initiator with a portion yₖ E of component E, where the number of alternations of steps 1 and 2 is sufficient to consume the respective portions.

In another embodiment, in stage 1 of the process, in a step 1, component C is reacted in the presence of a free-radical initiator with a portion yₖ E of component E, and the resultant reaction solution is reacted, in a step 2, in the presence of a free-radical initiator with a portion xₖ D of component D, where the number of alternations of steps 1 and 2 is sufficient to consume the respective portions.

In a further procedure, in stage 1 of the process, in a step 1, component C is reacted in the presence of a free-radical initiator with component E to give an alkylphosphonous acid and, in step 2, the resultant reaction solution is esterified with an alcohol and phosphonous ester produced here is removed by distillation and then, in a step 3, is reacted in the presence of a free-radical initiator or of a basic initiator with component D, and then stage 2 of the process is carried out.

It is preferable that the amounts used of the free-radical initiator are from 0.001 to 10 mol %, based on the phosphorus-containing compound.

It is preferable that the rate of feed of the free-radical initiator is from 0.01 to 10 mol % of initiator per hour, based on the phosphorus-containing compound.

It is preferable that the ratio of olefin to hypophosphite and/or hypophosphorous acid (on a molar basis) is from 1:3 to 3:0.5.

It is particularly preferable that the ratio of olefin to hypophosphite and/or hypophosphorous acid (on a molar basis) is from 1.5:3 to 2.5:1.

It is preferable that the reaction with the olefin component E takes place at a pressure of the olefin used of from 1 to 100 bar.

It is particularly preferable that the reaction with the olefin component E takes place at a pressure of the olefin used of from 2 to 50 bar.

It is preferable that the reaction of component C with components D and/or E takes place at a temperature of from 0 to 250° C.

It is preferable that the reaction of component C with components D and/or E takes place at a temperature of from 20 to 200° C.

It is particularly preferable that the ketones used comprise acetone, methyl ethyl ketone, diethyl ketone, methyl propyl ketone, isobutyl methyl ketone, 3-hexanone, 2-heptanone, 3-heptanone, 4-heptanone, 5-methyl-2-hexanone, 2-octanone, 3-octanone, or 5-methyl-3-heptanone.

It is preferable that the metal compounds used in stage 2 of the process are metal oxides, metal hydroxides, metal oxide hydroxides, metal sulfates, metal acetates, metal nitrates, metal chlorides, and/or metal alkoxides.

It is particularly preferable that the reaction takes place in stage 2 of the process at a temperature of from 80 to 120° C.

It is preferable that the reaction takes place in stage 2 of the process in an aqueous medium.

The inventive processes provide access to monocarboxy-functionalized dialkylphosphinic salts in completely halogen-free form, their freedom from halogen here being at a level not accessible in the prior art hitherto.

The inventive processes have the advantage of using halogen-free starting materials from the start, with the result that the final products are likewise completely halogen-free. The content of halogens—if indeed there is any such content—is below the detectable limit. In contrast, all processes known hitherto from the prior art lead to substantially higher halogen content in the respective final product.

The invention also provides the use of mixtures as claimed in one or more of claims 1 to 4 as flame retardants or for preparation of flame retardants.

It is preferable that the flame retardant comprises from 0.1 to 90% by weight of the mixtures as claimed in one or more of claims 1 to 3 and from 0.1 to 50% by weight of further additives, where the entirety of the components always amounts to 100% by weight.

It is particularly preferable that the flame retardant comprises from 10 to 80% by weight of the mixtures as claimed in one or more of claims 1 to 3 and from 10 to 40% by weight of further additives, where the entirety of the components always amounts to 100% by weight.

The invention also provides the use of mixtures as claimed in one or more of claims 1 to 3 in flame-retardant molding compositions.

It is preferable that the flame-retardant molding composition comprises from 5 to 30% by weight of the mixtures as claimed in one or more of claims 1 to 3, from 5 to 9% by weight of polymer or a mixture of the same, from 5 to 40% by weight of additives, and from 5 to 40% by weight of filler, where the entirety of the components always amounts to 100% by weight.

The invention also relates to the use of mixtures as claimed in one or more of claims 1 to 3 as flame retardant in flame-retardant moldings in flame-retardant films, in flame-retardant filaments, and in flame-retardant fibers.

It is preferable that the moldings, films, filaments, and fibers comprise from 5 to 30% by weight of the mixtures as claimed in one or more of claims 1 to 3, from 5 to 90% by weight of polymer or a mixture of the same, from 5 to 40% by weight of additives, and from 5 to 40% by weight of filler, where the entirety of the components always amounts to 100% by weight.

The abovementioned additives are preferably antioxidants, antistatic agents, blowing agents, further flame retardants, heat stabilizers, impact modifiers, processing auxiliaries, lubricants, light stabilizers, antidrip agents, compatibilizers, reinforcing materials, nucleating agents, additives for laser marking, hydrolysis stabilizers, chain extenders, color pigments, and/or plasticizers.

If X=Y, the molar ratio of monocarboxy-functionalized dialkylphosphinic acid to the metal can be 1:1 or 1:2.

In the invention, halogen means fluorine, chlorine, bromine, or iodine, and in one embodiment means chlorine.

There is a need for a process which can prepare salts of monocarboxy-functionalized dialkylphosphinic acids and which can be carried out in a simple and cost-effective manner with minimum involvement of halogen, and which gives unitary products of high purity. This type of process should also be markedly superior in terms of environmental technology to those known hitherto.

A further object of the invention is therefore to provide a process which can prepare salts of monocarboxy-functionalized dialkylphosphinic acid and which avoids the abovementioned disadvantages of the prior art, and which starts from hypophosphorous acid or its salts.

The inventive process has considerable advantages over the prior art, since it entirely avoids phosphonous dihalides and other halogen-containing compounds. With this, the inventive salts of monocarboxy-functionalized dialkylphosphinic acid are also less corrosive than the salts obtainable hitherto of monocarboxy-functionalized dialkylphosphinic acids. The lower corrosivity is advantageous not only for handling during the preparation process but also during use as flame retardant.

In stage 1 of the process, component C is reacted in the presence of a free-radical initiator with component D and E in a solvent, components D and E being respectively fed separately (in series or in sequence) rather than simultaneously.

If the component D used is not a free carboxylic acid but a carboxylic ester, hydrolysis has to be carried out prior to or after the reaction described, in order to obtain the free carboxylic acid.

Surprisingly, the monocarboxy-functionalized dialkylphosphinic acid can be obtained in good yields via iterative reaction of α,β-unsaturated carboxylic acids or α,β-unsaturated carboxylic esters and olefins with derivatives of hypophosphorous acid without isolation of the respective monoalkylphosphinic acid derivative. Reaction with an α,β-unsaturated carboxylic ester also requires a hydrolysis step, in order to obtain the free monocarboxy-functionalized dialkylphosphinic acid.

Esterification of the phosphonous acid to give the corresponding monoester can, for example, be achieved via reaction with relatively high-boiling-point alcohols, while using azeotropic distillation to remove the water formed.

The addition reaction in step c) preferably takes place in the presence of catalysts.

It is preferable that these are basic catalysts. As an alternative, it is also possible to use free-radical initiators or cationic initiators.

It is preferable that the basic initiators are alkali metal alcoholates and/or alkaline earth metal alcoholates. It is particularly preferably that sodium methanolate or sodium ethanolate is used.

It is preferable that the hydrolysis of the ester takes place in the presence of a strong mineral acid. It is preferable that this is concentrated sulfuric acid.

It is preferable that the ratio of α,β-unsaturated carboxylic acid derivative and olefins to hypophosphite and/or hypophosphorous acid (on a molar basis) in stage 1 of the process, in accordance with the formula is for the molar ratios: 0.01≦xₖ and yₖ≦α, α=1-3, p=0.5-3.0, and n=1-100, preferably 0.05≦xₖ and yₖ≦α, α=1-1.5, p=0.8-1.2, n=2-20.

It is preferable that inorganic solvents, organic solvents, or any desired mixture of the same are used.

It is preferable that the inorganic solvent used comprises water. It is preferable that the pH is adjusted to from 0 to 14 in the case of aqueous solvent, particularly preferably from 2 to 9.

It is preferable that the pH is adjusted using mineral acids, acidic salts, carboxylic acids, alkalis and/or electrolytes, e.g. sodium bisulfate, sodium bisulfite, and/or potassium bisulfite. It is preferable that the carboxylic acids are formic acid, acetic acid, propionic acid, butyric acid, and/or relatively-long-chain carboxylic acids, and/or their dimers, oligomers, and/or polymers. It is preferable that, in stage 1 of the process, the salt of hypophosphorous acid is a salt whose cation is an element of the 1^{st} main group and/or whose cation is based on an organically substituted element of the 5^{th} main group. It is particularly preferable that it is an ammonium salt or an alkali metal salt, in particular the sodium salt.

It is preferable that, in stage 1 of the process, the hypophosphorous acid is prepared in situ from salts of hypophosphorous acid and from at least one mineral acid, the ratio of additive acid to hypophosphite (based on equivalents) being from 0:1 to 2:1.

Suitable free-radical initiators for the inventive processes are any of the systems which generate free radicals. Preferred free-radical initiators are peroxo compounds, such as peroxomonosulfuric acid, potassium persulfate (potassium peroxomonosulfate), caroate (TM), oxones (TM), peroxodisulfuric acid, potassium persulfate (potassium peroxodisulfate), sodium persulfate (sodium peroxodisulfate), ammonium persulfate (ammonium peroxodisulfate).

Particular preference is given to compounds which can form peroxides in the solvent system, e.g. sodium peroxide, sodium peroxide diperoxohydrate, sodium peroxide diperoxohydrate hydrate, sodium peroxide dihydrate, sodium peroxide octahydrate, lithium peroxide, lithium peroxide monoperoxohydrate trihydrate, calcium peroxide, strontium peroxide, barium peroxide, magnesium peroxide, zinc peroxide, potassium hyperoxide, potassium peroxide diperoxohydrate, sodium peroxoborate tetrahydrate, sodium peroxoborate trihydrate, sodium peroxoborate monohydrate, anhydrous sodium peroxoborate, potassium peroxoborate peroxohydrate, magnesium peroxoborate, calcium peroxoborate, barium peroxoborate, strontium peroxoborate, potassium peroxoborate, peroxomonophosphoric acid, peroxodiphosphoric acid, potassium peroxodiphosphate, ammonium peroxodiphosphate, potassium ammonium peroxodiphosphates (double salt), sodium carbonate peroxohydrate, urea peroxohydrate, ammonium oxalate peroxide, barium peroxide peroxohydrate, calcium hydrogen peroxides, calcium peroxide peroxohydrate, ammonium triphosphate diperoxophosphate hydrate, potassium fluoride peroxohydrate, potassium fluoride triperoxohydrate, potassium fluoride diperoxohydrate, sodium pyrophosphate diperoxohydrate, sodium pyrophosphate diperoxohydrate octahydrate, potassium acetate peroxohydrate, sodium phosphate peroxohydrate, sodium silicate peroxohydrate.

Particular preference is given to hydrogen peroxide, performic acid, peracetic acid, benzoyl peroxide, di-tert-butyl peroxide, dicumyl peroxide, 2,4-dichlorobenzoyl peroxide, decanoyl peroxide, lauroyl peroxide, cumene hydroperoxide, pinene hydroperoxide, p-menthane hydroperoxide, tert-butyl hydroperoxide, acetylacetone peroxide, methyl ethyl ketone peroxide, succinic acid peroxide, dicetyl peroxydicarbonate, tert-butyl peroxyacetate, tert-butyl peroxymaleate, tert-butyl peroxybenzoate, acetylcyclohexylsulfonyl peroxide.

It is also preferable that water-soluble azo compounds are used as free-radical initiator.

Suitable azo initiators are those such as ®VAZO 52, ®VAZO 64 (AIBN), ®VAZO 67, ®VAZO 88, ®VAZO 68 from Dupont-Biesteritz, V-70 2,2′-azobis(4-methoxy-2,4-dimethylvaleronitrile), V-65 2,2′-azobis(2,4-dimethylvaleronitrile), V-601 dimethyl 2,2′-azobis(2-methylpropionate), V-59 2,2′-azobis(2-methylbutyronitrile), V-40, VF-096 1,1′-azobis(cyclohexane-1-carbonitrile), V-30 1-[(cyano-1-methylethyl)azo]formamide, VAm-110 2,2′-azobis(N-butyl-2-methylpropionamide), VAm-111 2,2′-azobis(N-cyclohexyl-2-methylpropionamide), VA-046B 2,2′-azobis[2-(2-imidazolin-2-yl)propane disulfate dihydrate, VA-057 2,2′-azobis[N-(2-carboxyethyl)-2-methylpropionamidine]tetrahydrate, VA-061 2,2′-azobis[2-(2-imidazolin-2-yl)propane], VA-080 2,2′-azobis{2-methyl-N-[1,1-bis(hydroxymethyl)-2-hydroxyethyl]propionamide}, VA-085 2,2′-azobis{2-methyl-N-[2-(1-hydroxybutyl)]propionamide}, VA-086 2,2′-azobis[2-methyl-N-(2-hydroxyethyl)propionamide] from Wako Chemicals.

Further preference is given to azo initiators such as 2-tert-butylazo-2-cyanopropane, dimethyl azodiisobutyrate, azodiisobutyronitrile, 2-tert-butylazo-1-cyanocyclohexane, 1-tert-amylazo-1-cyanocyclohexane. Preference is moreover given to alkyl perketals such as 2,2-bis(tert-butylperoxy)butane, ethyl-3,3-bis(tert-butylperoxy)butyrate, 1,1-di-(tert-butylperoxy)cyclohexane.

It is preferable that the amounts used of the free-radical initiator are from 0.001 to 10 mol %, based on the phosphorus-containing compound, amounts of from 0.05 to 5 mol % being particularly preferable.

It is preferable that the feed rate of the free-radical initiator is from 0.01 to 10 mol % of initiator per hour, based on the phosphorus-containing compound.

It is preferable that the free-radical initiator is used in the solvent mentioned.

It is also preferable that the olefins used in stage 1 of the process comprise cyclic olefins, e.g. cyclopentene, cyclohexene, cyclohexenols, cyclohexenones, cycloheptene, cyclooctene, cyclooctenols, and/or cyclooctenones.

In another embodiment functionalized olefins are used, e.g. allyl isothiocyanate, allyl methacrylate, 2-allylphenol, N-allylthiourea, 2-(allylthio)-2-thiazoline, allyltrimethylsilane, allyl acetate, allyl acetoacetate, allyl alcohol, allylamine, allylbenzene, allyl cyanide, allyl cyanoacetate, allylanisole, trans-2-pentenal, cis-2-pentenonitrile, 1-penten-3-ol, 4-penten-1-ol, 4-penten-2-ol, trans-2-hexenal, trans-2-hexen-1-ol, cis-3-hexen-1-ol, 5-hexen-1-ol, styrene, α-methylstyrene, 4-methylstyrene, vinyl acetate, 9-vinyl anthracene, 2-vinylpyridine, 4-vinylpyridine, and/or 1-vinyl-2-pyrrolidone.

It is preferable that in stage 1 of the process during the reaction with component D the atmosphere is composed of from 50 to 99.9% by weight, preferably from 70 to 95% by weight, of constituents of the solvent and of component D.

It is preferable that during the reaction with the olefin (component E) the atmosphere is composed of from 50 to 99.9% by weight, preferably from 70 to 95% by weight, of constituents of the solvent and olefin.

The atmosphere preferably comprises gaseous components which do not participate in the reaction.

The gaseous components are preferably oxygen, nitrogen, carbon dioxide, noble gases, hydrogen, and/or alkanes.

It is preferable that in stage 1 of the process the reaction takes place during addition of component D preferably at a pressure of from 1 to 20 bar.

It is preferable that in stage 1 of the process during the reaction of component C with components D or E the reaction solution is subject to an intensity of mixing corresponding to a rotational Reynolds number of from 1 to 1 000 000, preferably from 100 to 100 000.

It is preferable that in stage 1 of the process olefin, α,β-unsaturated carboxylic acids (derivatives), free-radical initiator, solvent, and hypophosphorous acid, and/or salts thereof are intimately mixed with energy input of from 0.083 to 10 kW/m³, preferably from 0.33 to 1.65 kW/m³.

Preferred apparatuses are stirred tanks, stirred-tank cascades, flow tubes, bubble columns, and scrubbers.

It is preferable that gaseous olefin components are introduced via nozzles (e.g. venturi nozzles), gassing stirrers, turbine stirrers, and/or disk stirrers.

It is preferable that in stage 2 of the process, the monocarboxy-functionalized dialkylphosphinic acids and/or their alkali metal salts obtained in stage 1 of the process are reacted with metal compounds of Mg, Ca, Al, Zn, Ti, Sn, Zr, Ce, or Fe to give the monocarboxy-functionalized dialkylphosphinic salts of these metals.

It is preferable that the reaction of the monocarboxy-functionalized dialkylphosphinic acid and/or its salts with metals and/or metal compounds in stage II) of the process for tetravalent metal ions or metals with a stable tetravalent oxidation state is carried out with a molar ratio of carboxy-functionalized dialkylphosphinic acid/salt to metal of from 6:1 to 1:2.5.

It is preferable that the reaction of the monocarboxy-functionalized dialkylphosphinic acid and/or its salts with metals and/or metal compounds in stage II) of the process for trivalent metal ions or metals with a stable trivalent oxidation state is carried out with a molar ratio of monocarboxy-functionalized dialkylphosphinic acid/salt to metal of from 4.5:1 to 1:2.5.

It is preferable that the reaction of the monocarboxy-functionalized dialkylphosphinic acid and/or its salts with metals and/or metal compounds in stage II) of the process for divalent metal ions or metals with a stable divalent oxidation state is carried out with a molar ratio of monocarboxy-functionalized dialkylphosphinic acid/salt to metal of from 3:1 to 1:2.5.

It is preferable that the reaction of the monocarboxy-functionalized dialkylphosphinic acid and/or its salts with metals and/or metal compounds in stage II) of the process for monovalent metal ions or metals with a stable monovalent oxidation state is carried out with a molar ratio of monocarboxy-functionalized dialkylphosphinic acid/salt to metal of from 2.5:1 to 1:3.5.

It is preferable that monocarboxy-functionalized alkali metal dialkylphosphinate obtained in stage I) of the process is converted to the dialkylphosphinic acid and that this is reacted in stage II) of the process with metal compounds of Mg, Ca, Al, Zn, Ti, Sn, Zr, Ce, or Fe, to give the monocarboxy-functionalized dialkylphosphinates of these metals.

It is preferable that monocarboxy-functionalized dialkylphosphinic acid obtained in stage I) of the process is converted to an alkali metal dialkylphosphinate and that this is reacted in stage II) of the process with metal compounds of Mg, Ca, Al, Zn, Ti, Sn, Zr, Ce, or Fe, to give the monocarboxy-functionalized dialkylphosphinates of these metals.

It is preferable that the metal compounds of Mg, Ca, Al, Zn, Ti, Sn, Zr, Ce, or Fe for stage II) of the process are metals, metal oxides, metal hydroxides, metal oxide hydroxides, metal borates, metal carbonates, metal hydroxocarbonates, metal hydroxocarbonate hydrates, mixed metal hydroxocarbonates, mixed metal hydroxocarbonate hydrates, metal phosphates, metal sulfates, metal sulfate hydrates, metal hydroxosulfate hydrates, mixed metal hydroxosulfate hydrates, metal oxysulfates, metal acetates, metal nitrates, metal fluoride, metal fluoride hydrates, metal chloride, metal chloride hydrates, metal oxychlorides, metal bromides, metal iodides, metal iodide hydrates, metal derivatives of a carboxylic acid, and/or metal alkoxides.

It is preferable that the metal compounds are aluminum chloride, aluminum hydroxide, aluminum nitrate, aluminum sulfate, titanyl sulfate, zinc nitrate, zinc oxide, zinc hydroxide, and/or zinc sulfate.

Preference among the aluminum compounds is given to metallic aluminum and aluminum salts having anions of the seventh main group, e.g. aluminum fluoride, aluminum fluoride trihydrate, aluminum chloride (anhydrous, crystallized; anhydrous, sublimed), aluminum chloride hexahydrate, aluminum hydroxychloride, ALCHLOR®-AC from Hardman Australia, basic aluminum chloride solution, aluminum chloride solution, sulfate-conditioned polyaluminum chloride solution (PACS) from Lurgi Lifescience, OBRAFLOC 18® from Oker Chemie GmbH, Alkaflock®, Ekocid® 60 grades, Sachtoklar® grades, Ekofloc® grades, Ekozet grades from Sachtleben, Locron® and Parimal® grades from Clariant, anhydrous aluminum bromide, aluminum iodide, aluminum iodide hexahydrate.

Preference is given to aluminum salts having anions of the sixth main group, e.g. aluminum sulfide, aluminum selenide.

Preference is given to aluminum salts having anions of the fifth main group, e.g. aluminum phosphide, aluminum hypophosphite, aluminum antimonide, aluminum nitride, and also aluminum salts having anions of the fourth main group, e.g. aluminum carbide, aluminum hexafluorosilicate; and aluminum salts having anions of the first main group, e.g. aluminum hydride, aluminum calcium hydride, aluminum borohydride, or else aluminum salts of the oxo acids of the seventh main group, e.g. aluminum chlorate.

Preference is given to aluminum salts of the oxo acids of the sixth main group, e.g. aluminum sulfate, aluminum sulfate hydrate, aluminum sulfate hexahydrate, aluminum sulfate hexadecahydrate, aluminum sulfate octadecahydrate, aluminum sulfate solution from Ekachemicals, liquid aluminum sulfate from Oker Chemie GmbH, sodium aluminum sulfate, sodium aluminum sulfate dodecahydrate, aluminum potassium sulfate, aluminum potassium sulfate dodecahydrate, aluminum ammonium sulfate, aluminum ammonium sulfate dodecahydrate, magaldrate (Al₅Mg₁₀(OH)₃₁(SO₄)₂×nH₂O).

Preference is also given to aluminum salts of the oxo acids of the fifth main group, e.g. aluminum nitrate nonahydrate, aluminum metaphosphate, aluminum phosphate, low-density aluminum phosphate hydrate, monobasic aluminum phosphate, monobasic aluminum phosphate solution; and aluminum salts of the oxo acids of the fourth main group, e.g. aluminum silicate, aluminum magnesium silicate, aluminum magnesium silicate hydrate (almasilate), aluminum carbonate, hydrotalcite (Mg₆Al₂(OH)₁₆CO₃*nH₂O), dihydroxyaluminum sodium carbonate, NaAl(OH)₂CO₃, and aluminum salts of the oxo acids of the third main group, e.g. aluminum borate, or else aluminum salts of the pseudohalides, e.g. aluminum thiocyanate.

Preference is given to aluminum oxide (purum, purissimum, technical, basic, neutral, acidic), aluminum oxide hydrate, aluminum hydroxide, or mixed aluminum oxide hydroxide, and/or polyaluminum hydroxyl compounds, these preferably having an aluminum content of from 9 to 40% by weight.

Preferred aluminum salts are those having organic anions, e.g. aluminum salts of mono-, di-, oligo-, or polycarboxylic acids, e.g. aluminum diacetate, basic aluminum acetate, aluminum subacetate, aluminum acetotartrate, aluminum formate, aluminum lactate, aluminum oxalate, aluminum tartrate, aluminum oleate, aluminum palmitate, aluminum monosterarate, aluminum stearate, aluminum trifluoromethanesulfonate, aluminum benzoate, aluminum salicylate, aluminum hexaurea sulfate triiodide, aluminum 8-oxyquinolate.

Among the zinc compounds, preference is given to elemental, metallic zinc, and also to zinc salts having inorganic anions, e.g. zinc halides (zinc fluoride, zinc fluoride tetrahydrate, zinc chlorides (butter of zinc), bromides, zinc iodide).

Preference is given to zinc salts of the oxo acids of the third main group (zinc borate, e.g. ®Firebrake ZB, ®Firebrake 415, ®Firebrake 500), and also zinc salts of the oxo acids of the fourth main group ((basic) zinc carbonate, zinc hydroxide carbonate, anhydrous zinc carbonate, basic zinc carbonate hydrate, (basic) zinc silicate, zinc hexafluorosilicate, zinc hexafluorosilicate hexahydrate, zinc stannate, zinc hydroxide stannate, zinc magnesium aluminum hydroxide carbonate), and zinc salts of the oxo acids of the fifth main group (zinc nitrate, zinc nitrate hexahydrate, zinc nitrite, zinc phosphate, zinc pyrophosphate); and zinc salts of the oxo acids of the sixth main group (zinc sulfate, zinc sulfate monohydrate, zinc sulfate heptahydrate), and zinc salts of the oxo acids of the seventh main group (hypohalites, halites, halates, e.g. zinc iodate, and perhalates, e.g. zinc perchlorate).

Preference is given to zinc salts of the pseudohalides (zinc thiocyanate, zinc cyanate, zinc cyanide).

Preference is given to zinc oxides, zinc peroxides (e.g. zinc peroxide), zinc hydroxides, or mixed zinc oxide hydroxides (standard zinc oxide, e.g. from Grillo, activated zinc oxide, e.g. from Rheinchemie, zincite, calamine).

Preference is given to zinc salts of the oxo acids of the transition metals (zinc chromate(VI) hydroxide (zinc yellow), zinc chromite, zinc molybdate, e.g. ™Kemgard 911 B, zinc permanganate, zinc molybdate-magnesium silicate, e.g. ™Kemgard 911 C). Preferred zinc salts are those having organic anions, among which are zinc salts of mono-, di-, oligo-, and polycarboxylic acids, salts of formic acid (zinc formates), of acetic acid (zinc acetates, zinc acetate dihydrate, Galzin), of trifluoroacetic acid (zinc trifluoroacetate hydrate), zinc propionate, zinc butyrate, zinc valerate, zinc caprylate, zinc oleate, zinc stearate, of oxalic acid (zinc oxalate), of tartaric acid (zinc tartrate), citric acid (tribasic zinc citrate dihydrate), benzoic acid (benzoate), zinc salicylate, lactic acid (zinc lactate, zinc lactate trihydrate), acrylic acid, maleic acid, succinic acid, of amino acids (glycine), of acidic hydroxy functions (zinc phenolate, etc.), zinc para-phenolsulfonate, zinc para-phenolsulfonate hydrate, zinc acetylacetonate hydrate, zinc tannate, zinc dimethyldithiocarbamate, zinc trifluoromethanesulfonate.

Preference is given to zinc phosphide, zinc selenide, zinc telluride.

Among the titanium compounds are metallic titanium, and also titanium salts having inorganic anions, e.g. chloride, nitrate, or sulfate ions, or else having organic anions, e.g. formate or acetate ions. Particular preference is given to titanium dichloride, titanium sesquisulfate, titanium(IV) bromide, titanium(IV) fluoride, titanium(III) chloride, titanium(IV) chloride, titanium(IV) chloride tetrahydrofuran complex, titanium(IV) oxychloride, titanium(IV) oxychloride-hydrochloric acid solution, titanium(IV) oxysulfate, titanium(IV) oxysulfate-sulfuric acid solution, or else titanium oxides. Preferred titanium alkoxides are titanium(IV) n-propoxide (®Tilcom NPT, ®Vertec NPT), titanium(IV) n-butoxide, titanium chloride triisopropoxide, titanium(IV) ethoxide, titanium(IV) 2-ethylhexyl oxide (®Tilcom EHT, ®Vertetec EHT).

Among the tin compounds, preference is given to metallic tin, and also tin salts (stannous chloride, stannous chloride dihydrate, stannic chloride), and tin oxides, and stannic tert-butoxide as preferred tin alkoxide.

Among the cerium compounds, preference is given to the cerium(III) salts (cerium(III) fluoride, cerium(III) chloride heptahydrate, cerium(III) nitrate hexahydrate).

Among the zirconium compounds, preference is given to metallic zirconium and zirconium salts, such as zirconium(IV) chloride, zirconium sulfate, zirconium sulfate tetrahydrate, zirconyl acetate, zirconyl chloride, zirconyl chloride octahydrate. Further preferred compounds are zirconium oxides, and zirconium(IV) tert-butoxide, as preferred zirconium alkoxide.

It is preferable that the reaction in stage II) of the process of monocarboxy-functionalized dialkylphosphinic acids and/or their alkali metal salts with metal compounds of Mg, Ca, Al, Zn, Ti, Sn, Zr, Ce, or Fe to give the monocarboxy-functionalized dialkylphosphinic salts of these metals takes place at a solids content of the monocarboxy-functionalized dialkylphosphinic salts of these metals of from 0.1 to 70% by weight, preferably from 5 to 40% by weight.

It is preferable that the reaction in stage II) of the process takes place at a temperature of from 20 to 250° C., preferably at a temperature of from 80 to 120° C.

It is preferable that the reaction in stage 2 of the process takes place at a pressure of from 1 Pa to 200 MPa, preferably from 0.01 MPa to 10 MPa.

It is preferable that the reaction in stage 2 of the process continues for a reaction time of from 1*10⁻⁷ to 1*10² h.

It is preferable that the monocarboxy-functionalized dialkylphosphinic salts of the metals Mg, Ca, Al, Zn, Ti, Sn, Zr, Ce, or Fe from stage 2 of the process are isolated via solid/liquid separation processes or via hydrocyclone methods, filtering, and/or centrifuging, from the reaction mixture of stage 2 of the process.

It is preferable that the monocarboxy-functionalized dialkylphosphinic salt of the metals Mg, Ca, Al, Zn, Ti, Sn, Zr, Ce, or Fe isolated from the reaction mixture in stage 2 of the process via filtering and/or centrifuging is dried.

It is preferable that the product mixture obtained in stage 1 of the process is reacted with the metal compounds in stage 2 of the process without further purification.

It is preferable that the reaction in stage 2 of the process takes place in the solvent system provided via stage 1.

It is preferable that the reaction in stage 2 of the process takes place in the solvent system provided after it has been modified. It is preferable that the solvent system is modified via addition of acidic components, solubilizers, foam inhibitors, etc.

In another embodiment of the process, the product mixture obtained in stage 2 of the process is worked up.

In another embodiment of the process, the product mixture obtained in stage 1 of the process is worked up and then the dialkylphosphinic acids and/or their alkali metal salts obtained in stage 1 of the process are reacted in stage 2 of the process with the metal compounds.

It is preferable that the product mixture is worked up by isolating the dialkylphosphinic acids and/or their alkali metal salts.

It is preferable that the isolation step takes place via removal of the solvent system, e.g. via concentration by evaporation.

It is preferable that the isolation step takes place via removal of the solvent system and of the ancillary components dissolved therein, e.g. via solid/liquid separation processes.

It is preferable that the product mixture is worked up by removing insoluble by-products, e.g. via solid/liquid separation processes.

It is preferable that the residual moisture level of the monocarboxy-functionalized dialkylphosphinic salt of the metals Mg, Ca, Al, Zn, Ti, Sn, Zr, Ce, or Fe is from 0.01 to 10% by weight, preferably from 0.1 to 1% by weight.

It is preferable that the average particle size of the monocarboxy-functionalized dialkylphosphinic salt of the metals Mg, Ca, Al, Zn, Ti, Sn, Zr, Ce, or Fe is from 0.1 to 2000 μm, preferably from 10 to 500 μm.

It is preferable that the bulk density of the monocarboxy-functionalized dialkylphosphinic salt of the metals Mg, Ca, Al, Zn, Ti, Sn, Zr, Ce, or Fe is from 80 to 800 g/l, preferably from 200 to 700 g/l.

It is preferable that the Pfrengle flowability of the monocarboxy-functionalized dialkylphosphinic salt of the metals Mg, Ca, Al, Zn, Ti, Sn, Zr, Ce, or Fe is from 0.5 to 10, preferably from 1 to 5.

The claimed processes overall give mixtures which comprise from 99.995 to 99.999999% of monocarboxy-functionalized dialkylphosphinic salt and from 10⁻⁶ to 0.0005% of halogen content.

The invention also provides use of the inventive mixtures for the preparation of flame retardants for thermoplastic polymers, such as polyesters, polystyrene, or polyamide and for thermosets.

The invention also provides flame retardants which comprise the inventive mixtures.

The invention also provides the use of the inventive mixtures as intermediate for the preparation of flame retardants.

The invention moreover provides polymer moldings, polymer films, polymer filaments, and polymer fibers, comprising inventively prepared low-halogen-content monocarboxy-functionalized dialkylphosphinic salts of the metals Mg, Ca, Al, Zn, Ti, Sn, Zr, Ce, or Fe.

The invention in particular provides the use of the inventive mixtures as flame retardants for thermoplastic polymers, such as polyesters, polystyrene, or polyamide, and for thermoset polymers, such as unsaturated polyester resins, epoxy resins, polyurethanes, or acrylates.

The invention in particular provides the use of the inventive mixtures as intermediate for preparation of flame retardants, for thermoplastic polymers such as polyesters, polystyrene, or polyamide, and for thermoset polymers such as unsaturated polyester resins, epoxy resins, polyurethanes, or acrylates.

Suitable polystyrenes are polystyrene, poly(p-methylstyrene), and/or poly(alpha-methylstyrene).

It is preferable that the suitable polystyrenes are copolymers of styrene or alpha-methylstyrene with dienes or with acrylic derivatives, e.g. styrene-butadiene, styrene-acrylonitrile, styrene-alkyl methacrylate, styrene-butadiene-alkyl acrylate, styrene-butadiene-alkyl methacrylate, styrene-maleic anhydride, styrene-acrylonitrile-methyl acrylate; or a mixture of high impact resistance composed of styrene copolymers and of another polymer, e.g. of a polyacrylate, of a diene polymer, or of an ethylene-propylene-diene terpolymer; or else block copolymers of styrene, e.g. styrene-butadiene-styrene, styrene-isoprene-styrene, styrene-ethylene/butylene-styrene, or styrene-ethylene/propylene-styrene.

It is preferable that the suitable polystyrenes are graft copolymers of styrene or alpha-methylstyrene, e.g. styrene on polybutadiene, styrene on polybutadiene-styrene copolymers or on polybutadiene-acrylonitrile copolymers, styrene and acrylonitrile (and, respectively, methacrylonitrile) on polybutadiene; styrene, acrylonitrile, and methyl methacrylate on polybutadiene; styrene and maleic anhydride on polybutadiene; styrene, acrylonitrile, and maleic anhydride or maleimide on polybutadiene; styrene and maleimide on polybutadiene, styrene and alkyl acrylates, respectively, alkyl methacrylates on polybutadiene, styrene and acrylonitrile on ethylene-propylene-diene terpolymers, styrene and acrylonitrile on polyalkyl acrylates or on polyalkyl methacrylates, styrene and acrylonitrile on acrylate-butadiene copolymers, or else a mixture of these, e.g. those known as ABS polymers, MBS polymers, ASA polymers, or AES polymers.

It is preferable that the polymers are also polyamides and copolyamides which derive from diamines and from dicarboxylic acids, and/or from aminocarboxylic acids or from the corresponding lactams, examples being nylon-2, 12, nylon-4 (poly-4-aminobutyric acid, ®Nylon 4, DuPont), nylon-4,6 (poly(tetramethyleneadipamide), poly(tetramethyleneadipicdiamide), ®Nylon 4/6, DuPont), nylon-6 (polycaprolactam, poly-6-aminohexanoic acid, ®Nylon 6, DuPont, ®Akulon K122, DSM; ®Zytel 7301, DuPont; ®Durethan B 29, Bayer), nylon-6,6 (poly(N,N′-hexamethyleneadipic diamide), ®Nylon 6/6, DuPont, ®Zytel 101, DuPont; ®Durethan A30, ®Durethan AKV, ®Durethan AM, Bayer; ®Ultramid A3, BASF), nylon-6,9 (poly(hexamethylenenonane diamide), ®Nylon 6/9, DuPont), nylon-6,10 (poly(hexamethylenesebacamide), ®Nylon 6/10, DuPont), nylon-6,12 (poly(hexamethylenedodecanediamide), ®Nylon 6/12, DuPont), nylon-6/6,6 (poly(hexamethyleneadipamide-co-caprolactam), ®Nylon 6/66, DuPont), nylon-7 (poly-7-aminoheptanoic acid, ®Nylon 7, DuPont), nylon-7,7 (polyheptamethylenepimelamide, ®Nylon 7,7, DuPont), nylon-8 (poly-8-aminooctanoic acid, ®Nylon 8, DuPont), nylon-8,8 (polyoctamethylenesuberamide, ®Nylon 8,8, DuPont), nylon-9 (poly-9-aminononanoic acid, ®Nylon 9, DuPont), nylon-9,9 (polynonamethyleneazelamide, ®Nylon 9,9, DuPont), nylon-10 (poly-10-amino-decanoic acid, ®Nylon 10, DuPont), nylon-10,9 (poly(decamethyleneazelamide), ®Nylon 10,9, DuPont), nylon-10,10 (polydecamethylenesebacamide, ®Nylon 10,10, DuPont), nylon-11 (poly-11-aminoundecanoic acid, ®Nylon 11, DuPont), nylon-12 (polylaurolactam, ®Nylon 12, DuPont, ®Grillamid L20, Ems Chemie), aromatic polyamides derived from m-xylene, diamine, and adipic acid; polyamides prepared from hexamethylenediamine and iso- and/or terephthalic acid (polyhexamethyleneisophthalamide polyhexamethyleneterephthalamide) and, if appropriate, from an elastomer as modifier, e.g. poly-2,4,4-trimethylhexamethyleneterephthalamide or poly-m-phenyleneisophthalamide. Block copolymers of the abovementioned polyamides with polyolefins, with olefin copolymers, with ionomers, or with chemically bonded or grafted elastomers; or with polyethers, e.g. with polyethylene glycol, polypropylene glycol, or polytetramethylene glycol. Also EPDM- or ABS-modified polyamides or copolyamides; and also polyamides condensed during processing (“RIM polyamide systems”).

Suitable polyesters derive from dicarboxylic acids and from dialcohols and/or from hydroxycarboxylic acids or from the corresponding lactones, e.g. polyethylene terephthalate, polybutylene terephthalate (®Celanex 2500, ®Celanex 2002, Celanese; ®Ultradur, BASF), poly-1,4-dimethylolcyclohexane terephthalate, polyhydroxybenzoates, and also block polyether esters which derive from polyethers having hydroxy end groups; and polyesters modified with polycarbonates or modified with MBS.

Preferred additives for the inventive flame retardants are antioxidants such as aromatic amines, sterically hindered phenols (butylated hydroxytoluene (BHT)), thiobisphenol, relatively high-molecular-weight polyphenols, tetrakis(methylene[2,5-di-tert-butyl-4-hydroxyhydrocinnamate])methane (®Irganox 1010), octadecyl 3,5-di-tert-butyl-4-hydroxyhydrocinnamate (®Irganox 1076), organophosphites (tris(nonylphenyl)phosphite (TNPP)), thioesters (distearyl 3,3′-thiodipropionates, ditridecyl 3,3′-thiodipropionate, dilauryl 3,3′-thiodipropionate), metal deactivators (®Irganox 1024), vitamin E (alpha-tocopherol), lactone, hydroxylamine.

Preferred additives for the inventive flame retardants are antistatic agents, such as fatty acid esters (glycerol, polyethylene glycol esters, sorbitol esters), quaternary ammonium compounds, ethoxylated amines, alkylsulfonates.

Preferred additives for the inventive flame retardants are blowing agents such as azodicarbonamide, p,p-oxybis(benzenesulfonyl hydrazide) (OBSH), 5-phenyltetrazole (5PT), p-toluenesulfonylsemicarbazide (TSSC), trihydrazinotriazine (THT).

Preferred additives for the inventive flame retardants are flame retardants such as alumina trihydrate, antimony oxide, brominated aromatic or cycloaliphatic hydrocarbons, phenols, ethers, chloroparaffin, hexachlorocyclopentadiene adducts (Dechloran Plus, Occidental Chemical Co), red phosphorus, melamine derivatives, melamine cyanurates, ammonium polyphosphates, magnesium hydroxide.

Preferred additives for the inventive flame retardants are heat stabilizers such as lead stabilizers, (dibasic lead phthalate, dibasic lead stearate, lead silicate, monobasic and tribasic lead sulfate, dibasic lead carbonate, dibasic lead phosphite), mixed metal salts (barium cadmium salts of, and barium zinc salts and calcium zinc salts of, 2-ethylhexylcarboxylic acid), stearic acid, ricinoleic acid, and/or lauric acid and, respectively, substituted phenols, organotin stabilizers (mono- and dialkyltin mercaptides, (thioglycolates), dialkyltin carboxylates (maleates, laurates, tin esters)), secondary heat stabilizers (alkyl/aryl organophosphites, epoxy compounds of unsaturated fatty acids, and esters of fatty acids).

Preferred additives for the inventive flame retardants are impact modifiers/processing auxiliaries such as acrylates, acrylonitrile-butadiene-styrene (ABS), chlorinated polyethylene (CPE), ethylene-propylene terpolymer (EPT), ethylene-vinyl acetate (EVA), methacrylate-butadiene-styrene (MBS).

Preferred additives for the inventive flame retardants are lubricants such as fatty acid amides (fatty acid monoamides, fatty acid bisamides, oleamides, erucamides, ethylenebisstearamide (EBSA), ethylenebisoleamide (EBOA)), fatty acid/esters of fatty acids (C₁₆-C₁₈ (palmitic acid, stearic acid, oleic acid)), fatty acid alcohols (cetyl alcohol, stearyl alcohol), waxes (paraffin waxes, polyethylene waxes), metal stearates (calcium stearate, zinc stearate, magnesium stearate, barium stearate, aluminum stearate, cadmium stearate, lead stearate).

Preferred additives for the inventive flame retardants are light stabilizers such as UV absorbers (alkyl-substituted hydroxybenzophenones e.g. 2-hydroxy-4-alkoxybenzophenones, alkyl-substituted hydroxybenzothiazoles e.g. 2-hydroxy-3,5-dialkylbenzotriazoles), UV quenchers (nickel diethyldithiocarbamate and zinc diethyldithiocarbamate, n-butylaminenickel 2,2′-thiobis(4-tert-octylphenolate), nickel bis(monoethyl 3,5-di-tert-butyl-4-hydroxybenzyl)phosphonate), free-radical inhibitors (bis(2,2′,6,6′-tetramethyl-4-piperidyl)sebacate (HALS)), agents that decompose hydroperoxide (dithiophosphates).

Further preference is given to antidrip agents, compatibilizers, fillers, reinforcing materials, nucleating agents, additives for laser marking, hydrolysis stabilizers, chain extenders, color pigments, and plasticizers.

The inventive mixtures are preferably used in molding compositions which are further used to produce polymer moldings. Preferred process for production of polymer moldings is injection molding.

The invention is illustrated in non-limiting fashion by the examples below.

### EXAMPLE 1

636 g (6 mol) of sodium hypophosphite monohydrate dissolved in 860 g of water in a pressure reactor (glass autoclave) were used as initial charge. 432 g (6 mol) of acrylic acid and 73.4 g of a 7% strength hydrogen peroxide solution (2.5 mol %, based on acrylic acid) were added dropwise at from 65 to 80° C. at atmospheric pressure over a period of 2 h, from different vessels. Ethylene was then introduced into the reactor at from 80 to 105° C. by way of a reducing valve adjusted to 3 bar, until saturation had been achieved. 73.4 g of a 7% strength hydrogen peroxide solution (2.5 mol %, based on ethylene) were fed uniformly over a period of 6 h, with constant stirring (energy input of 0.8 kW/m³), at ethylene pressure of from 2.5 to 2.9 bar and temperature of from 80 to 105° C.

After a continued reaction time of 1 h, the system was depressurized and the reaction mixture was neutralized with about 660 g of 50% strength sodium hydroxide solution (pH 7). A mixture of 2596 g (4.02 mol of aluminum) of a 46% strength aqueous solution of Al₂(SO₄)₃.14H₂O and 15.0 g of 98% strength H₂SO₄ (2.5 mol %, based on P content) was added at 90° C., within a period of 1 h. The resultant solid was then removed by filtration, washed with 2 l of hot water, and dried at 130° C. in vacuo. Yield: 765 g (70% of theory) of aluminum(III) 3-(ethylhydroxyphosphinyl)propionate as colorless salt; chlorine content: <0.1 ppm.

### EXAMPLE 2

636 g (6 mol) of sodium hypophosphite monohydrate dissolved in 860 g of water were used as initial charge in a pressure reactor (glass autoclave). 432 g (6 mol) of acrylic acid and 428.4 g of a 5% strength sodium peroxodisulfate solution (1.5 mol %, based on acrylic acid) were added drop wise at from 65 to 80° C. at atmospheric pressure within a period of 2 h, from different feed vessels. Ethylene was then introduced at from 80 to 105° C. into the reactor by way of a reducing valve adjusted to 3 bar, until saturation had been achieved. 428.4 g of a 5% strength sodium peroxodisulfate solution (1.5 mol %, based on ethylene) were then fed uniformly over a period of 6 h, with constant stirring (energy input of 0.8 kW/m³), at ethylene pressure of from 2.5 to 2.9 bar and temperature of from 80 to 105° C.

After a continued reaction time of 1 h, the reaction mixture was neutralized with about 330 g of 50% strength sodium hydroxide solution (pH 7). 4184 g (7.8 mol of calcium) of a 44% strength aqueous solution of Ca(NO₃)₂.4H₂O were added at 80° C., within a period of 2 h. The resultant solid was then removed by filtration, washed with 2 l of hot water, and dried at 130° C. in vacuo. Yield: 820 g (67% of theory) of calcium(II) 3-(ethylhydroxyphosphinyl)propionate as colorless salt; chlorine content: <0.1 ppm.

### EXAMPLE 3

636 g (6 mol) of sodium hypophosphite monohydrate dissolved in 860 g of water were used as initial charge in a pressure reactor (glass autoclave). Once the reaction mixture had been heated to 100° C., ethylene was introduced into the reactor by way of a reducing valve adjusted to 3 bar, until saturation had been achieved. A solution of 428.4 g of a 5% strength sodium peroxodisulfate solution (1.5 mol %, based on ethylene) was fed uniformly over a period of 4 h, with constant stirring, at ethylene pressure of from 2.5 to 2.9 bar and temperature of from 100 to 130° C. After depressurization, 602 g (7 mol) of methacrylic acid and 500 g of a 5% strength sodium peroxodisulfate solution (1.5 mol %, based on methacrylic acid) were added drop wise within a period of 1 h at from 90 to 100° C. at atmospheric pressure, from different feed vessels.

After a continued reaction time of 1 h, the reaction mixture was neutralized with about 660 g of 50% strength sodium hydroxide solution (pH 7). A mixture of 2596 g (4.02 mol of aluminum) of a 46% strength aqueous solution of Al₂(SO₄)₃.14H₂O and 15.0 g of 98% strength H₂SO₄ (2.5 mol %, based on P content) was added at 85° C., within a period of 1.2 h. The resultant solid was then removed by filtration, washed with 2 l of hot water, and dried at 130° C. in vacuo. Yield: 614 g (52% of theory) of aluminum(III) 3-(ethylhydroxyphosphinyl)-2-methylpropionate as colorless salt; chlorine content: <0.1 ppm.

### EXAMPLE 4

By analogy with example 3, 636 g (6 mol) of sodium hypophosphite monohydrate dissolved in 860 g of water were reacted in a pressure reactor (glass autoclave) with ethylene in the presence of 428.4 g of a 5% strength sodium peroxodisulfate solution (1.5 mol %, based on ethylene). After depressurization, 432 g (6 mol) of acrylic acid and 428.4 g of a 5% strength sodium peroxodisulfate solution (1.5 mol %, based on acrylic acid) were added drop wise at from 90 to 100° C. at atmospheric pressure within a period of 1 h from different feed vessels. After a continued reaction time of 1 h, the reaction mixture was neutralized with about 660 g of 50% strength sodium hydroxide solution (pH 7). A mixture of 4363 g (4.02 mol of cerium) of a 40% strength aqueous solution of Ce(NO₃)₃.6H₂O and 15.0 g of 98% strength H₂SO₄ (2.5 mol %, based on P content) was added at 100° C., within a period of 0.8 h. The resultant solid was then removed by filtration, washed with 2 l of hot water, and dried at 130° C. in vacuo. Yield: 1006 g (65% of theory) of cerium(III) 3-(ethylhydroxyphosphinyl)propionate as colorless salt; chlorine content: <0.1 ppm.

### EXAMPLE 5

636 g (6 mol) of sodium hypophosphite monohydrate and 15 g of concentrated sulfuric acid dissolved in 860 g of water were used as initial charge in a pressure reactor (glass autoclave). Once the reaction mixture had been heated to 120° C., propylene was introduced into the reactor by way of a reducing valve adjusted to 3 bar, until saturation had been achieved. 214 g of a 5% strength sodium peroxodisulfate solution (1.5 mol %, based on propylene) were reacted with propylene over a period of 2 h, with constant stirring (energy input of 1.1 kW/m³) at propylene pressure of from 2.5 to 2.9 bar and temperature of from 120 to 140° C. 516.5 g (6 mol) of methyl acrylate were then admixed in the presence of 428 g of a 5% strength sodium peroxodisulfate solution (1.5 mol %, based on methyl acrylate) and propylene was then again added in the presence of 214 g of a 5% strength sodium peroxodisulfate solution.

After a continued reaction time of 1 h, the reaction mixture was neutralized with about 330 g of 50% strength sodium hydroxide solution (pH 7). A mixture of 2388 g (2.01 mol of aluminum) of a 25% strength aqueous solution of Al₂(SO₄)₃.14H₂O and 15.0 g of 98% strength H₂SO₄ (2.5 mol %, based on P content) was added at 90° C., within a period of 1 h. The resultant solid was then removed by filtration, washed with 2 l of hot water, and dried at 130° C. in vacuo. Yield: 824 g (68% of theory) of the methyl ester of aluminum(III) 3-(propylhydroxyphosphinyl)propionate as colorless salt; chlorine content: <0.1 ppm.

### EXAMPLE 6

636 g (6 mol) of sodium hypophosphite monohydrate dissolved in 860 g of water were used as initial charge in a pressure reactor (glass autoclave). Once the reaction mixture had been heated to 100° C., ethylene was introduced into the reactor by way of a reducing valve adjusted to 3 bar, until saturation had been achieved. 428.4 g of a 5% strength sodium peroxodisulfate solution (1.5 mol %, based on ethylene) were fed uniformly over a period of 4 h, with constant stirring, at ethylene pressure of from 2.5 to 2.9 bar and temperature of from 100 to 130° C. After depressurization, 216 g (3 mol) of acrylic acid and 214.2 g of a 5% strength sodium peroxodisulfate solution (1.5 mol, based on acrylic acid) were added dropwise at from 90 to 100° C. at atmospheric pressure within a period of 1 h, from different feed vessels.

The two steps were repeated at appropriate temperatures by again adjusting to an ethylene pressure of from 2.5 to 2.9 bar and then metering 214.2 g of a 5% strength sodium peroxodisulfate solution over a period of 2 h. 216 g (3 mol) of acrylic acid were then again admixed with the reaction mixture in the presence of 214.2 g of a 5% strength sodium peroxodisulfate solution.

After a continued reaction time of 1 h, the reaction mixture was neutralized with about 660 g of 50% strength sodium hydroxide solution (pH 7). A mixture of 5120 g (6 mol of zinc) of a 40% strength aqueous solution of ZnSO₄.7H₂O and 15.0 g of 98% strength H₂SO₄ (2.5 mol %, based on P content) was added at 95° C., within a period of 2.5 h. The resultant solid was then removed by filtration, washed with 2 l of hot water, and dried at 130° C. in vacuo. Yield: 995 g (72% of theory) of zinc(II) 3-(ethylhydroxyphosphinyl)propionate as colorless salt; chlorine content: <0.1 ppm.

### EXAMPLE 7

By analogy with example 6, 636 g (6 mol) of sodium hypophosphite monohydrate were reacted with ethylene and acrylic acid. After a continued reaction time of 1 h, the reaction mixture was neutralized with about 660 g of 50% strength sodium hydroxide solution (pH 7). 3218 g (6 mol of calcium) of a 44% strength aqueous solution of Ca(NO₃)₂.4H₂O were added at 75° C., within a period of 2 h. The resultant solid was then removed by filtration, washed with 2 l of hot water, and dried at 130° C. in vacuo. Yield: 857 g (72% of theory) of calcium(II) 3-(ethylhydroxyphosphinyl)propionate as colorless salt; chlorine content: <0.1 ppm.

### EXAMPLE 8

261 g (4.5 mol) of acetone and 588 g (3 mol) of 50% strength sulfuric acid were admixed with 792 g of a 50% strength aqueous solution of hypophosphorous acid (6 mol) and the reaction mixture was heated at reflux for 8 h. After cooling, the reaction mixture was neutralized with sodium hydroxide solution with cooling by ice, and the solvent was removed by distillation in vacuo. Ethanol was used to take up the residue and the insoluble salts were removed by filtration. The solvent of the filtrate was removed in vacuo. This gave 677 g (91% of theory) of 1-hydroxy-1-methylethylphosphinate.

### EXAMPLE 9

744 g (6 mol) of 1-hydroxy-1-methylethylphosphinate dissolved in 840 ml of water were used as initial charge, and then 432 g (6 mol) of acrylic acid and 428 g of a 5% strength sodium peroxodisulfate solution (1.5 mol %, based on acrylic acid) were added dropwise within a period of 2.5 h at from 95 to 100° C. from different feed vessels. Water was then removed by distillation in vacuo. Acetone was eliminated thermolytically at from 120 to 160° C. in vacuo and collected in a cold trap. 800 ml of water was used to take up the bottom product. The reaction mixture was heated to 115° C. in a pressure reactor and then ethylene was introduced into the reactor by way of a reducing valve adjusted to 3 bar until saturation had been achieved. 428 g of a 5% strength sodium peroxodisulfate solution (1.5 mol %, based on ethylene) were fed uniformly over a period of 5 h, with constant stirring, at ethylene pressure of from 2.5 to 2.9 bar and temperature of from 100 to 115° C.

After a continued reaction time of 1 h, the reaction mixture was neutralized with about 660 g of 50% strength sodium hydroxide solution (pH 7). A mixture of 2596 g (4.02 mol of aluminum) of a 46% strength aqueous solution of Al₂(SO₄)₃.14H₂O and 15.0 g of 98% strength H₂SO₄ (2.5 mol %, based on P content) was added at 85° C., within a period of 1.2 h. The resultant solid was then removed by filtration, washed with 2 l of hot water, and dried at 130° C. in vacuo. Yield: 819 g (75% of theory) of aluminum(III) 3-(ethylhydroxyphosphinyl)propionate as colorless salt; chlorine content: <0.1 ppm.

1. A mixture comprising:
A) from 98 to 100% by weight of at least one monocarboxy-functionalized dialkylphosphinic salt of the formula (I) 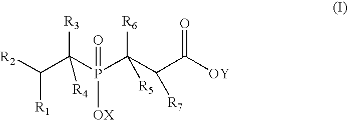
wherein X and Y are different, where X is Ca, Al, or Zn, and Y is methyl, ethyl, n-propyl, isopropyl, n-butyl, isobutyl, tert-butyl, phenyl, 2-hydroxyethyl, 2,3-dihydroxypropyl, 2-hydroxypropyl, 3-hydroxypropyl, 4-hydroxybutyl, 3-hydroxybutyl, 2-hydroxybutyl, 6-hydroxyhexyl, allyl or glycerol;
or X and Y are different and are Mg, Sb, Sn, Ge, Ti, Fe, Zr, Ce, Bi, Sr, Mn, Cu, Ni, Li, Na, K, H, or a protonated nitrogen base;
or X and Y are identical or different and are Ca, Al, or Zn;
R₁, R₂, R₃, R₄, R₅, R₆, and R₇ are identical or different and, independently of one another, are H, methyl, ethyl, n-propyl, isopropyl, n-butyl, isobutyl, tert-butyl, or phenyl, and
B) from 0 to 2% by weight of at least one halogen,
where the entirety of the components always amounts to 100% by weight.

2. The mixture as claimed in claim 1, comprising from 99.9995 to 100% by weight of the at least one monocarboxy-functionalized dialkylphosphinic salt of the formula (I) and from 0 to 0.0005% by weight of the at least one halogen.

3. The mixture as claimed in claim 1, wherein the at least one monocarboxy-functionalized dialkylphosphinic salt is aluminum(III) 3-(ethylhydroxyphosphinyl)propionate, calcium(II) 3-(ethylhydroxyphosphinyl)propionate, cerium(III) 3-(ethyl-hydroxyphosphinyl)propionate, zinc(II) 3-(ethylhydroxyphosphinyl)propionate, aluminum(III) 3-(ethylhydroxyphosphinyl)-2-methylpropionate, the methyl ester of aluminum(III) 3-(propylhydroxyphosphinyl)propionate, aluminum(III) 3-(propyl-hydroxyphosphinyl)propionate, zinc(II) 3-(propylhydroxyphosphinyl)propionate, aluminum(III) 3-(ethylhydroxyphosphinyl)butyrate, zinc(II) 3-(ethylhydroxy-phosphinyl)butyrate, aluminum(III) 3-(butylhydroxyphosphinyl)propionate, aluminum(III) 3-(propylhydroxyphosphinyl)butyrate, aluminum(III) 3-(ethylhydroxy-phosphinyl)pentanoate, aluminum(III) 3-(propylhydroxyphosphinyl)-2-methylpropionate, aluminum(III) 3-(butylhydroxyphosphinyl)-2-methylpropionate, aluminum(III) 3-(ethylhydroxyphosphinyl)-2-methylbutyrate, the methyl ester of aluminum(III) 3-(ethylhydroxyphosphinyl)propionate, the 2-hydroxyethyl ester of aluminum(III) 3-(ethylhydroxyphosphinyl)propionate, the 2-hydroxyethyl ester of zinc(II) 3-(ethylhydroxyphosphinyl)propionate, the 2,3-dihydroxypropyl ester of aluminum(III) 3-(ethylhydroxyphosphinyl)propionate, the allyl ester of aluminum(III) 3-(ethylhydroxyphosphinyl)-2-methylpropionate or a mixture thereof.

4. A process for preparation of a mixture as claimed in claim 1 comprising the steps of reacting, in a stage 1, hypophosphorous acid or a salt thereof (component C) of the formula II 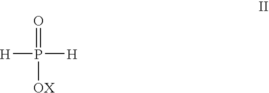
wherein X is H, Na, K, or NH₄; in the presence of at least one free-radical initiator with a t least one α,β-unsaturated carboxylic acid derivative (component D) of the formula III 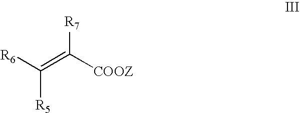
wherein R₅, R₆, and R₇ are defined as in formula I, and Z is H, C₁₋₈-alkyl, or C₆₋₁₈-aryl, or is Y; and with at least one olefin (component E) of the formula IV 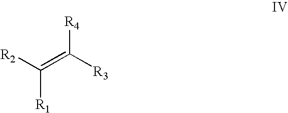
wherein R₁, R₂, R₃, and R₄ are defined as in formula I and, in a stage 2, reacting the resultant monocarboxy-functionalized dialkylphosphinic acid and/or its alkali metal salts with metal compounds of Mg, Ca, Al, Sb, Sn, Ge, Ti, Fe, Zr, Zn, Ce, Bi, Sr, Mn, or with a protonated nitrogen base to give the dialkylphosphinates of Mg, Ca, Al, Sb, Sn, Ge, Ti, Fe, Zr, Zn, Ce, Bi, Sr, or Mn or to give the nitrogen compound of formula I.

5. The process as claimed in claim 4, wherein X is H and Z is H, methyl, ethyl, n-propyl, isopropyl, n-butyl, isobutyl, tert-butyl, hydroxyethyl, or hydroxypropyl.

6. The process as claimed in claim 4, wherein, in stage 1, in a step 1, component C is reacted in the presence of at least one free-radical initiator with component E to give an alkylphosphonous acid in a resultant reaction solution and, in step 2, the resultant reaction solution is esterified with an alcohol to produce phosphonous ester in the resultant reaction solution and phosphonous ester is removed by distillation and, in a step 3, the resultant reaction solution is reacted in the presence of the at least one free-radical initiator or of a basic initiator with component D, and then stage 2 of the process is carried out.

7. The process as claimed in claim 6, wherein, in step 2, the alkylphosphonous acid is directly esterified with a linear or branched alcohol of the formula M-OH, where M is a linear or branched alkyl radical having from 1 to 10 carbon atoms.

8. The process as claimed in claim 7, wherein the alcohol is n-butanol, isobutanol, or ethylhexanol.

9. The process as claimed in claim 6, wherein component C is the ammonium or sodium salt of hypophosphorous acid.

10. The process as claimed in claim 4, wherein the at least one free radical initiator is a free-radical, anionic, cationic, or photochemical initiator.

11. The process as claimed in claim 4, wherein the at least one free radical initiator is a peroxide-forming compound, a peroxo compound, an azo compound or a mixture thereof.

12. The process as claimed in claim 4, wherein the at least one α,β-unsaturated carboxylic acid and at least one α,β-unsaturated carboxylic acid derivatives derivative are acrylic acid, methyl acrylate, ethyl acrylate, methacrylic acid, hydroxyethyl acrylate, crotonic acid, ethyl crotonate, tiglic acid (trans-2,3-dimethylacrylic acid), (trans-)2-pentenoic acid, furan-2-carboxylic acid, thiophene-2-carboxylic acid or a mixture thereof.

13. The process as claimed in claim 4, wherein the at least one olefin (component E) is ethylene, propylene, n-butene, isobutene, 1-hexene, 1-heptene, 1-octene, allyl alcohol, allylamine, allylbenzene, allylanisole, styrene, α-methylstyrene, 4-methylstyrene, vinyl acetate or a mixture thereof.

14. The process as claimed in claim 4, wherein the reaction of component C with component D, E or both takes place at a temperature of from 50 to 150° C.

15. A process for preparation of a mixture as claimed in claim 1, comprising the steps of m in stage 1 of the process, reacting component C, in a step 1, with a ketone to give 1-hydroxy-1-dialkylphosphinate, reacting the 1-hydroxy-1-dialkylphosphinate, in a step 2, in the presence of at least one free-radical initiator with component D, in a step 3, removing the ketone, and reacting the resultant reaction mixture, in a step 4, in the presence of the at least one free-radical initiator with component E, and then carrying out stage 2 of the process.

16. A process for preparation of a mixture as claimed in claim 1, comprising the steps of, in stage 1 of the process, reacting component C, in a step 1, with a ketone to give 1-hydroxy-1-dialkylphosphinate, reacting the 1-hydroxy-1-dialkylphosphinate, in a step 2, in the presence of at least one free-radical initiator with component E, in a step 3, removing the ketone, and reacting the resultant reaction mixture, in a step 4, in the presence of the at least one free-radical initiator with component D, and then carrying out stage 2 of the process.

17. The process as claimed in claim 4, wherein the metal compounds of stage 2 of are aluminum hydroxide, aluminum sulfates, zinc sulfate heptahydrate, magnesium chloride hexahydrate, calcium chloride dihydrate or a mixture thereof.

18. The process as claimed in claim 1, wherein the reaction in stage 2 takes place at a temperature of from 20 to 150° C.

19. A process of making a flame retardant or a flame retardant article comprising the step of adding a mixture as claimed in claim 1 to the flame retardant or flame retardant article during the manufacture of the flame retardant or the flame retardant article, wherein the flame retardant article is selected from the group consisting of flame-retardant molding compositions, flame-retardant moldings, flame-retardant films, flame-retardant filaments, and flame-retardant fibers.

20. The process as claimed in claim 19, wherein the flame retardant article comprises from 1 to 50% by weight of the mixture, from 1 to 99% by weight of a polymer or a mixture of the same, from 0 to 60% by weight of additives, and from 0 to 60% by weight of filler, where the entirety of the components always amounts to 100% by weight.

21. The process as claimed in claim 4, wherein the at least free radical initiator is selected from the group consisting of hydrogen peroxide, sodium peroxide, lithium peroxide, potassium persulfate, sodium persulfate, ammonium persulfate, sodium peroxodisulfate, potassium peroxoborate, peracetic acid, benzoyl peroxide, di-tert-butyl peroxide, peroxodisulfuric acid, azodiisobutyronitrile, 2,2′-azobis(2-amidinopropane) dihydrochloride, 2,2′-azobis(N,N′-dimethyleneisobutyramidine) dihydrochloride and mixtures thereof.

22. A flame retardant or flame retardant article made in accordance with the process of claim 20.
